(19) United States
(12) Patent Application Publication
(10) Pub. No.: US 2014/0176021 A1
(43) Pub. Date: Jun. 26, 2014

(54) Method and Apparatus for Controlling Light Intensity of Lamp

(71) Applicant: Kin Ming FUNG, Hong Kong (HK)

(72) Inventor: Kin Ming FUNG, Hong Kong (HK)

(21) Appl. No.: 14/192,880

(22) Filed: Feb. 28, 2014

Related U.S. Application Data
(63) Continuation-in-part of application No. 12/952,220, filed on Nov. 23, 2010, now abandoned.

(51) Int. Cl. H05B 33/08

(52) U.S. Cl. CPC H05B 33/0845
USPC 315/360

(57) ABSTRACT

An apparatus for controlling the light intensity of a lamp includes a light intensity control unit which includes a light intensity signal transmitter for transmitting a light intensity signal based on a user setting and a built-in module inside of the lamp which includes a light intensity signal receiver module configured for receiving the light intensity signal from the transmitter and a lamp driving module controlled by the light intensity signal receiver module and configured for controlling the light intensity of the lamp based on the light intensity signal. In adjusting the light intensity of the lamp, the built-in module is configured to change the light intensity from a current level everytime to a preset level firstly, keeps at the preset level for a first predetermined time, and then from the preset level to an adjusted level. A method for controlling the light intensity of a lamp is also provided.

### CROSS-REFERENCE TO RELATED APPLICATIONS

This application is a continuation-in-part application of U.S. patent application Ser. No. 12/952,220 filed on Nov. 23, 2010, which claims the benefit of U.S. Provisional Application No. 61/263,827, filed on Nov. 24, 2009; the contents of which are hereby incorporated by reference.

### FIELD OF THE PATENT APPLICATION

The present patent application relates to the control of light intensity of lamps and more particularly to a method and an apparatus for controlling the light intensity of a lamp in which a light intensity setting device is used to create the change of intensity with a wired or wireless system.

### BACKGROUND

The controlling method of typical light control systems is to directly adjust the light intensity dimming level and the effect occurs proportionally to the adjusting amount. With wired or wireless control, the level of intensity is achieved by a difference in voltage applied to the bulb. In a typical light control system, the external receiver for a value control to the bulb is used as a part of the system. The external receiver is created individually and acts as a linking device for the controller and the bulb.

### SUMMARY

The present patent application is directed to a method and an apparatus for controlling the light intensity of a lamp. In one aspect, the present patent application provides an apparatus for controlling the light intensity of a lamp. The apparatus includes a light intensity control unit, the light intensity control unit including a light intensity signal transmitter for transmitting a light intensity signal based on a user setting; and a built-in module integrated inside with the lamp, the built-in module including a light intensity signal receiver module configured for receiving the light intensity signal from the light intensity control unit and a lamp driving module controlled by the light intensity signal receiver module and configured for controlling the light intensity of the lamp based on the light intensity signal. In adjusting the light intensity of the lamp, the built-in module is configured to change the light intensity from a current level to a preset level firstly, and then from the preset level to an adjusted level each time.

The built-in module may be configured to change the light intensity from the current level to the preset level over a second predetermined time interval, to stay at the preset level for a first predetermined time, and to change the light intensity from the preset level to the adjusted level over a third predetermined time interval.

The built-in module may be configured to keep the light intensity at the preset level for a first predetermined time interval before changing the light intensity from the preset level to the adjusted level.

The current level and the adjusted level may be higher than or equal to a cut-off level and the preset level may be higher than the cut-off level.

The built-in module may be configured to change the light intensity from a starting intensity level that is equal to 3% to 20% of the maximum intensity of the lamp.

In another aspect, the present patent application provides a method for controlling the light intensity of a lamp. The method includes transmitting a light intensity signal based on a user setting through a light intensity control unit; receiving the light intensity signal with a light intensity signal receiver module; and controlling the light intensity of the lamp based on the light intensity signal with a lamp driving module controlled by the light intensity signal receiver module, the light intensity signal receiver module and the lamp driving module forming a built-in module integrated inside of the lamp. The light intensity of the lamp is changed from a current level to a preset level, to stay at the preset level and then from the preset level to an adjusted level.

The light intensity may be changed from the current level to the preset level over a second predetermined time interval, and may be changed from the preset level to the adjusted level over the third predetermined time interval.

The light intensity may be kept at the preset level for a first predetermined time interval before being changed from the preset level to the adjusted level.

The current level and the adjusted level may be higher than or equal to a cut-off level and the preset level may be higher than the cut-off level.

The light intensity may be changed from a starting intensity level that is equal to 3% to 20% of the maximum intensity of the lamp.

In yet another aspect, the present patent application provides an apparatus for controlling the light intensity of a lamp. The apparatus includes a light intensity control unit, the light intensity control unit including a light intensity signal transmitter for transmitting a light intensity signal based on a user setting; and a built-in module integrated inside of the lamp, the built-in module including a light intensity signal receiver module configured for receiving the light intensity signal from the light intensity signal transmitter, a lamp driving module controlled by the light intensity signal receiver module and configured for controlling the light intensity of the lamp based on the light intensity signal, and a power supply module configured for supplying a DC voltage to the light intensity signal receiver module and the lamp driving module. In adjusting the light intensity of the lamp, the built-in module is configured to change the light intensity from a current level to a preset level and then from the preset level to an adjusted level.

The apparatus may further include a rectification module connected to the power supply module and configured for transforming an AC power supply to a DC power supply.

The apparatus may further include an electromagnetic interference module connected with the rectification module and configured to reduce the electromagnetic interference to the apparatus.

In yet another aspect, the present patent application provides a method for controlling the light intensity of a lamp including the following steps:
S5: keeping the light intensity at the current level;
S6: checking whether receiving a command which is changing the light intensity from current level to an adjusted level with a light intensity signal receiver module, if yes, then enter S7; if not, then enter S5;
S7: changing the light intensity of the lamp from the current level to the preset level over a second predetermined time interval;
S8: keeping the light intensity of the lamp at the preset level over a first predetermined time;
S9: changing the light intensity of the lamp from the preset level to the adjusted level over a third predetermined time interval.

The method further includes the following steps:
S1: detecting a switching on of the lamp;
S2: starting up at zero intensity of the lamp;
S3: changing the light intensity from zero to a preset level over a fourth predetermined time interval;
S4: setting the light intensity of current level equal to the preset level.

The method further includes the following steps:
S10: checking whether the adjusted level is larger than a cut-off level; if yes, then enter S12, if not, then enter S11;
S11: turning off the lamp to zero intensity, setting the light intensity of current level equal to the zero intensity level and enter S5;
S12: setting the current level equal to the adjusted level and enter S5.

The preset level is equal to about 20% of a maximum intensity of the lamp.

### BRIEF DESCRIPTIONS OF THE DRAWINGS

FIG. 1A is a block diagram of a light intensity control unit for transmitting a light intensity signal in an apparatus for controlling the light intensity of a lamp according to an embodiment of the present invention.

FIG. 1B illustrates a built-in module for receiving the light intensity signal from the light intensity control unit and controlling the light intensity of a lamp in the embodiment as depicted in FIG. 1A.

FIG. 2 illustrates the change of the light intensity of the lamp when the light intensity is being adjusted by the apparatus for controlling the light intensity of a lamp in the embodiment as depicted in FIG. 1B.

FIG. 3 illustrates a flow chart of the method for controlling the light intensity of a lamp in the embodiment as depicted in FIG. 1B.

### DETAILED DESCRIPTION

Reference will now be made in detail to a preferred embodiment of the apparatus and the method for controlling the light intensity of a lamp disclosed in the present patent application, examples of which are also provided in the following description. Exemplary embodiments of the method and apparatus for controlling the light intensity of a lamp disclosed in the present patent application are described in detail, although it will be apparent to those skilled in the relevant art that some features that are not particularly important to an understanding of the apparatus and the method for controlling the light intensity of a lamp may not be shown for the sake of clarity.

Furthermore, it should be understood that the apparatus and the method for controlling the light intensity of a lamp disclosed in the present patent application is not limited to the precise embodiments described below and that various changes and modifications thereof may be effected by one skilled in the art without departing from the spirit or scope of the protection. For example, elements and/or features of different illustrative embodiments may be combined with each other and/or substituted for each other within the scope of this disclosure.

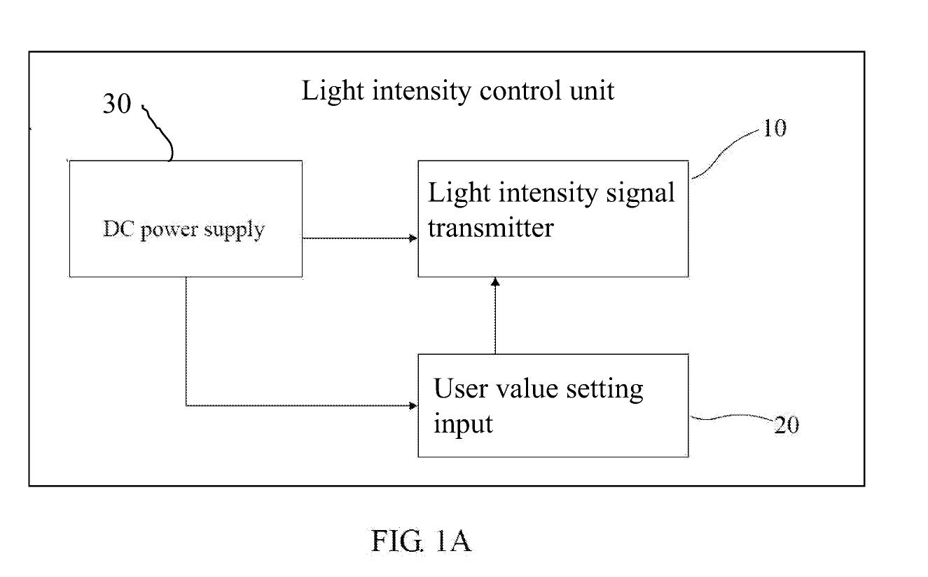

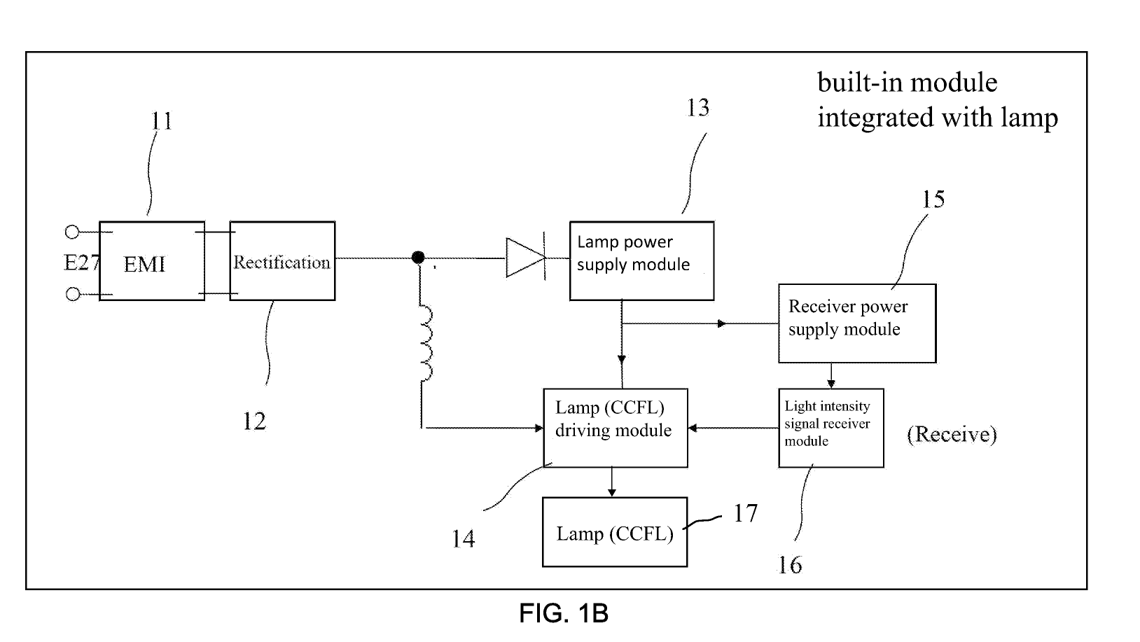

FIG. 1A is a block diagram of a light intensity control unit for transmitting a light intensity signal in an apparatus for controlling the light intensity of a lamp according to an embodiment of the present invention. Referring to FIG. 1A, the system is supplied by a DC power supply 30. A value may be entered to a setting input 20 by a user. The light intensity signal transmitter 10 receives the user setting and emits a light intensity signal based on the user setting to a built-in module so as to control the intensity of the lamp. The built-in module is hereafter described in more detail.

FIG. 1B illustrates a built-in module for receiving the light intensity signal from the light intensity signal transmitter and controlling the light intensity of a lamp. Referring to FIG. 1B, the EMI (Electromagnetic Interference) module 11 is connected to an E27 circuit and configured to reduce the EMI to the system. The electricity supply of the EMI 11 is transformed from AC to DC supply by the rectification module 12. The lamp power supply module 13 then gives a DC voltage to the CCFL (Cold Cathode Fluorescent Lamp) driving module 14 and the receiver power supply module 15. The CCFL driving module 14 controls the intensity and on/off of the CCFL lamp 17. The receiver power supply module 15 provides the electricity of the light intensity signal receiver module 16. The light intensity signal receiver module 16 receives the signal from the light intensity signal transmitter 10 (as shown in FIG. 1A) and gives signal to the CCFL driving module 14 to control the lamp (CCFL) 17. In this embodiment, the built-in module is integrated inside of the lamp.

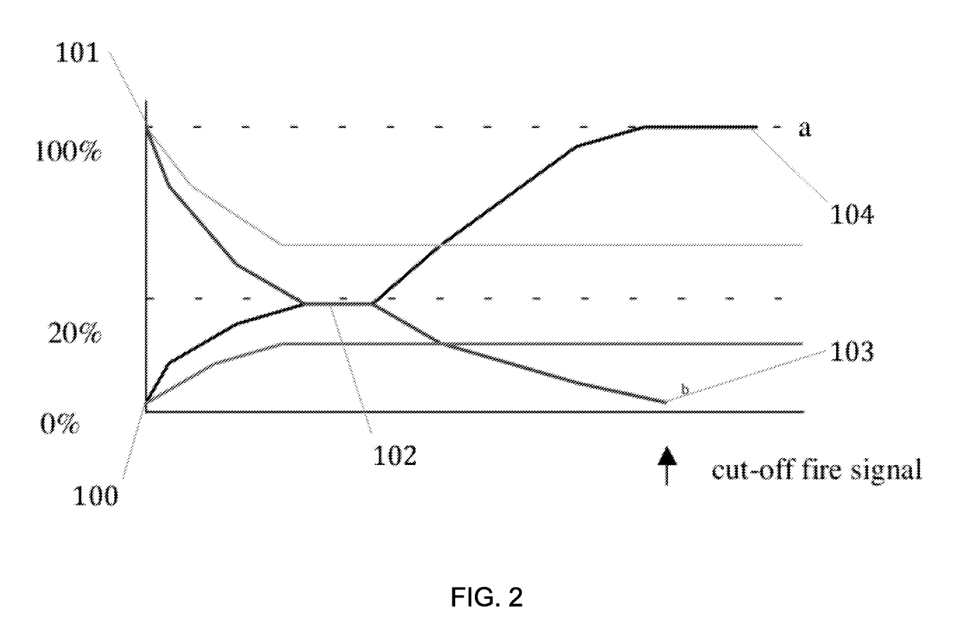

FIG. 2 illustrates the change of the light intensity of the lamp when the light intensity is being adjusted by the apparatus for controlling the light intensity of a lamp in the embodiment as depicted in FIG. 1B. Referring to FIG. 2, with the design of the light intensity dimming control method, the intensity of the lamp being controlled is varying before it is stable. It includes three levels of intensity, namely the current level, the preset level, and the adjusted level. The current and adjusted levels are any point that are higher than or equal to the point of cut-off percentage level 103. The preset level 102 is a reference percentage that is higher than the point of cut-off percentage 103, and it is preset in the system. It is about 20% in this embodiment as shown in FIG. 2. Therefore, there are two states varying from the current level 100 or 101 to the preset level 102 and from preset level 102 to the adjusted level 103 or 104.

Referring to FIG. 2, the light intensity dimming control starts, when being switched on, at a point 100 which prevents the unstable situation of the bulb flashing (the bulb flashes which can be recognized by human eyes) from happening. The light intensity of the lamp at the point 100 is in the range of 3%˜20% of the maximum intensity of the lamp. The points 100 and 103 are the levels of starting and ending of light intensity of lamp respectively. In the initial state, as the system is ON, the light intensity increases from the point 100 to the point 102 within a forth predetermined time (about one second) interval. With no adjustment, the intensity keeps on this preset value. When the adjustment starts, a first predetermined time period (about one second) is given as an ignorance time interval for keeping at the preset level. Then the light intensity increases from the point 102 to the point 104 or from the point 102 to the point 103 in a third predetermined time (about one second) interval.

In another state, as the current intensity is on any point ranging from the point 100 to the point 101, adjustment is made with the time interval of the second predetermined time interval (about one second) the intensity changes from the current point to the point 102 and keeps the intensity on the point 102 for the first predetermined time period (about one second). Then the intensity changes within the third predetermined time interval (about one second) from the point 102 to the adjusted level, which is in the range from the point 100 to the point 101.

In the termination state, as the system switches off, the light intensity changes after the second predetermined time interval (of about one second), from the current point to the point 102, keeps at point 102 for the first predetermined time period (about one second), and then from the point 102 to the point 103 within the third predetermined time interval (about one second).

All the intensity changes are in gradient, which means that in any particular time interval, the intensity is changed in only one direction (only increases or only decreases).

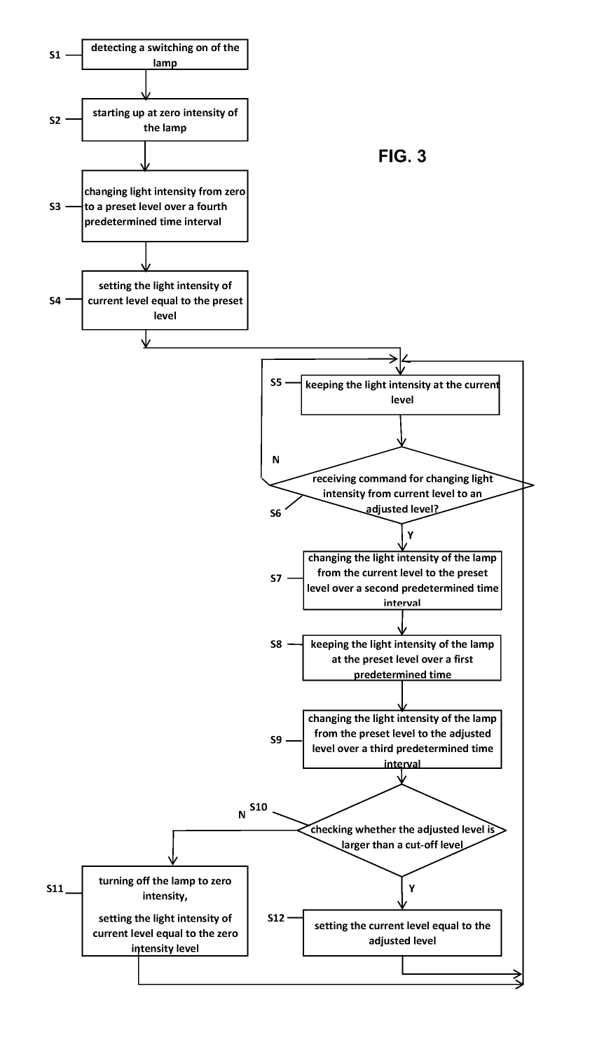

Referring to FIG. 3, a method for controlling the light intensity of a lamp comprising the following steps:
S1: detecting the switching on of the lamp;
S2: starting up at zero intensity of the lamp;
S3: changing the light intensity from zero to a preset level over a fourth predetermined time interval;
S4: setting the light intensity of current level equal to the preset level;
S5: keeping the light intensity at the current level;
S6: checking whether receiving a command which is changing the light intensity from current level to an adjusted level with a light intensity signal receiver module, if yes, then enter S7; if not, then enter S5;
S7: changing the light intensity of the lamp from the current level to the preset level over a second predetermined time interval;
S8: keeping the light intensity of the lamp at the preset level over a first predetermined time;
S9: changing the light intensity of the lamp from the preset level to the adjusted level over a third predetermined time interval;
S10: checking whether the adjusted level is larger than a cut-off level; if yes, then enter S12, if not, then enter S11;
S11: turning off the lamp to zero intensity, setting the light intensity of current level equal to the zero intensity level and enter S5;
S12: setting the current level equal to the adjusted level and enter S5.

The apparatus and method for controlling the light intensity of a lamp with the above limitations have the following advantages: when adjusting the light intensity of the lamp from a whatever current level to an adjusted level, the built-in module changes the light intensity from the current level firstly to a preset level, keeps the light intensity at the preset level over a first predetermined time interval and then changes the light intensity from the preset level to the adjusted level, which will cause no sudden, abrupt and sharp change of the light intensity. This would NOT cause discomfort in the eyes of users of the lamp controlled by the apparatus. The preset level of light intensity can be an energy saving level and also be an eye comfortable level. This will suggest a strong message to the users that we should keep the light intensity of the lamp at the preset level as often as possible.

While the present patent application has been shown and described with particular references to a number of embodiments thereof, it should be noted that various other changes or modifications may be made without departing from the scope of the present invention.

What is claimed is:

1. An apparatus for controlling the light intensity of a lamp comprising:
a light intensity control unit which comprises a light intensity signal transmitter for transmitting a light intensity signal based on a user setting; and
a built-in module integrated with the lamp, the built-in module comprising a light intensity signal receiver module which receives the light intensity signal from the light intensity signal transmitter and a lamp driving module controlled by the light intensity signal receiver module controls the light intensity of the lamp based on the light intensity signal; wherein:
in adjusting the light intensity of the lamp from a current level to an adjusted level, the built-in module changes the light intensity from the current level to a preset level, keeps the light intensity at the preset level over a first predetermined time interval and then changes the light intensity from the preset level to the adjusted level.

2. The apparatus for controlling the light intensity of a lamp of claim 1, wherein the built-in module changes the light intensity from the current-level to the preset level over a second predetermined time interval and changes the light intensity from the preset level to the adjusted level over a third predetermined time interval.

3. The apparatus for controlling the light intensity of a lamp of claim 1, wherein the built-in module changes the light intensity after a predetermined time interval.

4. The apparatus for controlling the light intensity of a lamp of claim 1, wherein the preset level is equal to about 20% of a maximum intensity of the lamp.

5. The apparatus for controlling the light intensity of a lamp of claim 4, wherein in every switching on of the lamp, the built-in module-changes the light intensity from a starting intensity level that is equal to about 3% to 20% of the maximum intensity of the lamp to the preset level over a fourth predetermined time interval and keeps at that level.

6. The apparatus for controlling the light intensity of a lamp of claim 1, wherein the adjusted level are higher than or equal to a cut-off level and the preset level is higher than the cut-off level.

7. The apparatus for controlling the light intensity of a lamp of claim 6, wherein in termination state of the lamp, the built-in module changes the light intensity from the current level to the preset level, keeps the light intensity of the lamp at the preset level over the first predetermined time and then changes the light intensity of the lamp from the preset level to the cut-off level.

8. A method for controlling the light intensity of a lamp comprising the following steps:
transmitting a light intensity signal based on a user setting through a light intensity control unit;
receiving the light intensity signal with a light intensity signal receiver module; and
controlling the light intensity of the lamp based on the light intensity signal with a lamp driving module controlled by the light intensity signal receiver module, the light intensity signal receiver module and the lamp driving module forming a built-in module integrated inside of the lamp; wherein:
in adjusting the light intensity of the lamp from a current level to an adjusted level, changing the light intensity of the lamp from the current level to a preset level; keeping the light intensity of the lamp at the preset level over a first predetermined time and then changing the light intensity of the lamp from the preset level to the adjusted level.

9. The method for controlling the light intensity of a lamp of claim 8, wherein the light intensity is changed from the current level to the preset level over a second predetermined time interval, and is changed from the preset level to the adjusted level over a third predetermined time interval.

10. The method for controlling the light intensity of a lamp of claim 8, wherein the light intensity is changed after a predetermined time interval.

11. The method for controlling the light intensity of a lamp of claim 8, wherein the preset level is equal to about 20% of a maximum intensity of the lamp.

12. The method for controlling the light intensity of a lamp of claim 11, wherein in every switching on of the lamp, the built-in module changes the light intensity from a starting intensity level that is equal to 3% to 20% of the maximum intensity of the lamp to the preset level over a fourth predetermined time interval and keeps at that level.

13. The method for controlling the light intensity of a lamp of claim 8, wherein the adjusted level are higher than or equal to a cut-off level and the preset level is higher than the cut-off level.

14. The method for controlling the light intensity of a lamp of claim 13, wherein in termination state of the lamp, the built-in module changes the light intensity from the current level to the preset level, keeps the light intensity of the lamp at the preset level over a first predetermined time and then changes the light intensity of the lamp from the preset level to the cut-off level.

15. A method for controlling the light intensity of a lamp comprising the following steps:
S5: keeping the light intensity at the current level;
S6: checking whether receiving a command which is changing the light intensity from current level to an adjusted level with a light intensity signal receiver module, if yes, then enter S7; if not, then enter S5;
S7: changing the light intensity of the lamp from the current level to the preset level over a second predetermined time interval;
S8: keeping the light intensity of the lamp at the preset level over a first predetermined time;
S9: changing the light intensity of the lamp from the preset level to the adjusted level over a third predetermined time interval.

16. The method for controlling the light intensity of a lamp of claim 15 further comprising the following steps:
S1: detecting a switching on of the lamp;
S2: starting up at zero intensity of the lamp;
S3: changing the light intensity from zero to a preset level over a fourth predetermined time interval;
S4: setting the light intensity of current level equal to the preset level.

17. The method for controlling the light intensity of a lamp of claim 15 further comprising the following steps:
S10: checking whether the adjusted level is larger than a cut-off level; if yes, then enter S12, if not, then enter S11;
S11: turning off the lamp to zero intensity, setting the light intensity of current level equal to the zero intensity level and enter S5;
S12: setting the current level equal to the adjusted level and enter S5.

18. The method for controlling the light intensity of a lamp of claim 16 further comprising the following steps:
S10: checking whether the adjusted level is larger than a cut-off level; if yes, then enter S12, if not, then enter S11;
S11: turning off the lamp to zero intensity, setting the light intensity of current level equal to the zero intensity level and enter S5;
S12: setting the current level equal to the adjusted level and enter S5.

19. The method for controlling the light intensity of a lamp of claim 15, wherein the preset level is equal to about 20% of a maximum intensity of the lamp.
